(19) United States
(12) Patent Application Publication
(10) Pub. No.: US 2006/0182851 A1
(43) Pub. Date: Aug. 17, 2006

(54) Food casing provided with an antimicrobial finish

(76) Inventor: Erna Kastl, HUENSTETTEN (DE)

Correspondence Address: Klaus Schweitzer;ProPat, 425-C South Sharon Amity Road, Charlotte, NC, 28211, US

(21) Appl. No.: 10/549,830

(22) PCT Filed: Apr. 21, 2004
(86) PCT No.: PCT/EP04/04206

§ 371 Date: Sep. 20, 2005

(30) Foreign Application Priority Data
Apr. 25, 2003 (DE) 103 19 006.6

(51) Int. Cl. A21D 13/00

(52) U.S. Cl. 426/138

(57) ABSTRACT

The invention relates to a preferably tubular food casing based on synthetic material, in particular polyamide, in which the layer, or at least one of the layers, includes at least one metal salt having antimicrobially active metal ions. The metal salt preferably includes ions of silver, copper or zinc. In the event of a multi-layered casing, the at least one outer layer comprises a said metal salt. In the production of the casing, preferably a master batch is used which comprises about 5 to 40% by weight of the metal salt. The food casing is preferably used as artificial sausage casing.

The invention relates to a polymer-based food casing having an antimicrobial finish, and also to a method for producing the casing.

Food casings, especially sausage casings, having an antimicrobial finish are already known. For instance, U.S. Pat. No. 3,864,449 discloses a sausage casing based on regenerated cellulose, which casing comprises a fat-soluble edible antimycotic, in particular para-hydroxybenzoic ester. In the production of the casing, the antimycotic is dissolved in an oil (for example castor oil). The oil having the constituents dissolved therein is then dispersed in a viscous solution and the dispersion is then extruded through an annular die. The finely divided oil droplets, after regeneration of the cellulose, are situated in the tubular casing and can release the active compound. Polymer-based casings which are produced by extrusion or coextrusion from a thermoplastic melt cannot be provided with an antimicrobial finish in this manner.

An antibacterial impregnation can also be achieved by applying a corresponding solution or suspension to a finished tubular casing. For instance, EP-A 0 384 319 discloses a composition which comprises a bacteriocin (in particular nisin or pediocin) obtainable from Pediococcus or Streptococcus species and a chelating agent. This composition can be applied to cellulose casings, and also to polymer casings (for example those based on polyolefins, polyamides, poly(ethylene terephthalate)s, poly(vinylidene chloride) copolymers or ethylene/vinyl acetate copolymers). Such an impregnation obviously does not act very persistently. Bacteriocins, in addition, are heat sensitive.

Polyamide-based sausage casings are frequently also produced in ready-to-stuff presoaked (“preconditioned”) form, since individual types of polyamide can absorb up to about 10% by weight of water. However, during storage, mold can spread on the presoaked casings, which precludes further use. To solve this problem, the aqueous soaking solutions were therefore admixed with fungicidally and/or bactericidally active components. Components which are suitable and permitted under food law are, in particular, potassium sorbate, para-hydroxybenzoic esters (PHB esters) or natamycin.

The object was still therefore to provide casings based on thermoplastic polymers, which casings are provided with an antimicrobial finish from the start, i.e. not just by an after-treatment. In addition they are to be simpler to produce, since an after-treatment with antibacterially active substances is no longer necessary. In addition, the antimicrobial finish is to be persistent, i.e. not leachable, and its activity, even after the action of heat, is not to decrease, or decrease only insignificantly. This is because, in the case of sausage casings, the action of heat can attain a temperature up to about 95° C., in the case of sterilization, for a short time also up to about 120° C. Also, relatively long storage of the food casing is not to impair the antimicrobial finish.

The object was achieved using metal salts which are added to the polymer melt before extrusion. In the finished casing, they release antimicrobially active metal ions and thus prevent or impede the growth of mold, bacteria, yeasts, fungi and other microorganisms.

The present invention thus relates to a single- or multi-layered synthetic-based food casing, wherein the layer or at least one of the layers comprises an antimicrobially active amount of at least one metal salt. The metal salt preferably comprises ions of silver, copper or zinc and/or other metal ions having antimicrobial, particularly antibacterial, activity.

The synthetic-based food casing is preferably a casing based on polyamide and/or copolyamide (hereinafter termed (co)polyamide).

The (co)polyamide is generally an aliphatic (co)polyamide, such as nylon 6 (poly(ε-caprolactam)=polyamide made of ε-caprolactam, or 6-aminohexanoic acid), nylon 6,6 (polyhexamethylene adipamide=polyamide made of hexamethylene diamide and adipic acid), nylon 6/6,6 (copolyamide made of ε-caprolactam, hexamethylenediamine and adipic acid), nylon 6/66,9 (copolyamide made from ε-caprolactam, hexamethylenediamine, adipic acid and azelaic acid), nylon 6/66,12 (copolyamide made of ε-caprolactam, hexamethylenediamine, adipic acid and laurolactam), nylon 6,9 (polyamide made from hexamethylenediamine and azelaic acid), nylon 6,10 (polyhexamethylenesebacamide=polyamide made from hexamethylenediamine and sebacic acid), nylon 6,12 (polyhexamethylenedodecanamide=copolyamide made from ε-caprolactam and ω-aminolaurolactam), nylon 4,6 (polytetramethylene-adipamide=polyamide made from tetramethylenediamine and adipic acid) or nylon 12 (poly(ε-laurolactam)). The aliphatic (co)polyamide can be blended with partially aromatic (co)polyamides, in particular amorphous partially aromatic (co)polyamides such as nylon 6I/6T (a copolyamide having units of hexamethylenediamine, isophthalic acid and terephthalic acid). The fraction of partially aromatic (co)polyamide is preferably no greater than 50% by weight, particularly preferably no greater than 30% by weight, in each case based on the total weight of all (co)polyamides. The (co)polyamide can, in addition, be blended with further polymers, in particular olefinic polymers, especially those which also act as adhesion promoters. Those which may be mentioned here are, for example, ethylene/(meth)acrylic acid copolymers. Further polymers can also pass into the casing material via a corresponding master batch comprising metal salt. This applies, for example, if a master batch based on polyethylene or polyester is incorporated into a polyamide layer.

The fraction of metal salt(s) in the single-layered casing, or in a correspondingly finished layer of the multi-layered casing, is generally about 0.005 to 4.0% by weight, preferably about 0.01 to 2.0% by weight. The fraction of metal ions is accordingly about 0.0025 to 2% by weight, preferably 0.005 to 1.0% by weight, based on the total weight of the casing or of a layer of the casing. In the multi-layered casings, preferably at least the outer layer comprises antimicrobially active metal salt(s).

The casing can, moreover, comprise generally customary additives, such as dyes or color pigments, UV stabilizers or the like. It is generally tubular, preferably also seamless. It can be unstretched or stretched. The casing can be stretched in a film-blowing method, or by biaxial orientation in what is termed a double-bubble method. In the latter method, first, by extrusion or coextrusion, a primary tube is produced which is cooled, then heated to the stretching temperature and stretched by a gas pressure acting from the inside. By heat setting, then a residual shrinkage expedient for sausage casings may be set. This residual shrinkage is generally no greater than 20% in the longitudinal and transverse directions (determined by placing in water of 90° C. for 5 minutes). In the multi-layered casing, the metal salt is, if appropriate, also present in the inner layer.

In a preferred embodiment, the metal salt is applied to a support. The support can be, for example, an aluminosilicate, especially a natural or synthetic zeolite, or a similar absorbent material. By ion-exchange processes, the aluminosilicate releases antimicrobially active metal ions (for example silver ions) and in exchange binds cations of the environment, such as sodium, potassium or calcium ions. By this means, a particularly long-lasting activity may be achieved. The aluminosilicate particles generally have a mean diameter of 1 to 15 μm, preferably 2 to 10 μm. They can be present up to about 40% by weight of metal ions. Suitable metal ion-containing aluminosilicates are disclosed, for example, in JP-A 02-153723. There, its use in sponge cloths is disclosed.

In the production of the inventive casing, use is preferably made of a master batch which comprises up to about 5 to 40% by weight, preferably 10 to 25% by weight, of at least one metal salt. A support material for the master batch is, for example, a polyolefin (in particular a polyethylene, a polypropylene, a copolymer having ethylene and propylene units, an ethylene/(C₄-C₈) α-olefin copolymer, a propylene/(C₄-C₈) α-olefin copolymer, or an ethylene/propylene/(C₄-C₈) α-olefin copolymer), or a polyamide. The master batch is mixed with the remaining constituents of the casing, or the relevant layer of the multi-layered casing, and then extruded or coextruded.

The further layers in the multi-layered embodiment are, in particular, layers based on polyolefins (especially polyethylene, polypropylene, ethylene/propylene copolymers or block copolymers, polybutylene etc.), polyesters, poly(vinylidene chloride) (PVDC), poly(ethylene-co-vinylacetate) and/or poly(ethylene-co-methylmethacrylate). Between the individual layers, in addition, preferably relatively thin (about 2 to 8 μm) adhesion layers can additionally be arranged which, for example, comprise or consist of polyolefins modified by functional groups. Including such adhesion layers, the inventive casing should comprise, for practical reasons, no more than 5 layers. To decrease the number of extruders required, in addition a symmetrical structure is expedient. For example, the composition of the inner layer is then identical to that of the outer layer.

The inventive single-layered or multi-layered tubular casing generally has a wall thickness of 15 to 150 μm, preferably from 20 to 130 μm, particularly preferably from 35 to 90 μm. Depending on the intended use, the diameter is expediently about 20 to 200 mm, preferably 30 to 150 mm.

The inventive casing has the essential advantage that it is antimicrobially finished in a persistent manner. The term “antimicrobially active” is here to be taken to mean activity against bacteria, yeasts, mold, algae, fungi and other microorganisms. Of importance, especially, is the antibacterial action, especially action against colibacteria, salmonellae and staphylococci. The antimicrobially active component is not dissolved out of the casing by water, fat or other food constituents. The antibacterial action is virtually not affected by heating, UV radiation, action of chemicals. The antibacterial finish does not impair the flavor, the odor, or the aroma of a food situated in the casing. A subsequent antibacterial finish, as is frequently described in the prior art, is no longer required. The inventive casing is thus substantially protected against infection by microorganisms, even when it is presoaked in a ready-to-stuff manner.

The examples hereinafter illustrate the invention. “pw” therein is “part(s) by weight”. Percentages are percentages by weight, unless stated otherwise or immediately obvious from the context.

### EXAMPLE 1

### comparison

A mixture of
80 pw of nylon 6 (the relative viscosity of a 1% strength solution of the polyamide in 96% pure sulfuric acid at a temperature of 20° C. was 4),
10 pw of amorphous nylon 6I/6T (®Selar PA 3426 from DuPont de Nemours Inc.; melt flow index: 90 g in 10 min at 275° C. and a load of 10 kg) and
10 pw of ethylene/methacrylic acid copolymer (®Nucrel 0903 HC from DuPont de Nemours Inc.; melt flow index: 2.5 g in 10 min at 190° C. and 2.16 kg load)
   was plasticized in a single-screw extruder at 240° C. to give a homogeneous melt. The melt was extruded through an annular die to form tubing having a diameter of 18 mm. This primary tubing was cooled rapidly after the extrusion, then heated to the temperature required for stretching, biaxially stretched by compressed air acting from the inside and by the action of a pinch-roll pair which exerts tension in the longitudinal direction. The area stretching ratio was 9.6. The stretched casing was then heat set, in which case the area stretching ratio remained virtually unchanged. The finished casing had a diameter of 66 mm.

### EXAMPLE 2

### Inventive Single-Layered Casino

A mixture of
78 pw of nylon 6 (as in Example 1),
10 pw of amorphous nylon 6I/6T (as in Example 1),
10 pw of ethylene/methacrylic acid copolymer (as in Example 1) and
2 pw of polyethylene having 20% metal oxide fraction (®Polybatch Abact 399 from Schulmann AG)
   was plasticized as described in Example 1 and processed to form a biaxially stretched and heat-set sausage casing.

### EXAMPLE 3

### Inventive Multi-Layered Casino

To produce the casing, the following polymer mixtures were used:

Mixture A:
88 pw of nylon 6 (as in Example 1),
10 pw of amorphous nylon 6I/6T (as in Example 1),
2 pw of polyethylene having a metal oxide fraction (®Polybatch Abact 400L from Schulmann AG)

Mixture B:
70 pw of low density polyethylene (LDPE, Lupolen 1441 from BASF AG having an MFI of 0.2 g in 10 min at 190° C. and 2.16 kg load) and
30 pw of a linear low density polyethylene modified by functional groups (LLDPE; the functional groups were introduced by treatment with maleic anhydride; ®Escor CTR 2000 from Exxon having an MFI of 3 g in 10 min at 190° C. and 2.16 kg load; the component acts as adhesion promoter toward polyamide)

Mixture C:
85 pw of nylon 6 (as in Example 1)
15 pw of amorphous nylon 6I/6T (as in Example 1)

The mixtures were plasticized in each case in separate single-screw extruders at 240° C., the resultant homogeneous melts were passed together through a 3-layer annular die and coextruded to form tubing of 18 mm diameter. The tubing was then processed as described to form a biaxially stretched and heat-set food casing. The area stretching ratio was 9.6. The finished casing had a diameter of 66 mm. Of the total wall thickness of 55 μm, the individual layers had the following shares:

| | |
|---|---|
| Outer layer (mixture A): | 30 μm |
| Middle layer (mixture B): | 20 μm |
| Inner layer (mixture C): | 5 μm |

### EXAMPLE 4

### Inventive Single-Layer Casing

A mixture of
90 pw of nylon 6,6 and
10 pw of PE having a metal oxide fraction (®Polybatch Abact 399 from Schulmann AG)
   was plasticized in a single-screw extruder at 280° C. to form a homogeneous melt and was extruded as described in Example 1 using an annular die to form a blown tube.

Determination of the Antibacterial Properties of the Food Casings:

For this, the bacteriostatic activity S was determined by the method described in JIS Z 2801 using Staphylococcus aureus ATCC 6538 as test organism. The following results were obtained:

| | | Reduction | |
|---|---|---|---|
| | | compared with | |
| | | casing according | |
| | Bacteriostatic | to Example 1 | |
| Example | activity S | [%] | Evaluation)* |
| 1 (comparison) | 0 | 0 | unsatisfactory |
| 2 | >1.9 | >98 | good |
| 3 | >1.9 | >98 | good |
| 4 | >1.9 | >98 | good |

)*the bacteriostatic activity S was assessed as follows:
<0.0 microbial growth, unsatisfactory antibacterial action
0.0 to <1.0 no significant microbial reduction, unsatisfactory antibacterial action
1.0 to <2.0 microbial reduction, good antibacterial action for certain applications
≧2.0 strong microbial reduction, good antibacterial action

1. A single- or multi-layered synthetic-based food casing comprising one or more layers, wherein the layer or at least one of the layers comprises an antimicrobially active amount of at least one metal salt.

2. The food casing as claimed in claim 1, wherein the metal salt comprises ions of silver, copper, zinc and/or other metal ions having antimicrobial activity.

3. The food casing as claimed in claim 1, wherein said food casing comprises polyamide and/or copolyamide.

4. The food casing as claimed in claim 1, wherein the (co)polyamide comprises an aliphatic (co)polyamide.

5. The food casing as claimed in claim 4, wherein the aliphatic (co)polyamide is blended with at least one partially aromatic (co)polyamide.

6. The food casing as claimed in claim 5, wherein the fraction of the at least one partially aromatic (co)polyamide is no greater than 50% by weight, based on the total weight of all (co)polyamides.

7. The food casing as claimed in claim 1, wherein the fraction of metal salt(s) in the single-layered casing, or in a layer of the multi-layered casing, is 0.005 to 4.0% by weight, based on the total weight of the casing or of the relevant layer in the casing.

8. The food casing as claimed in claim 1, wherein the fraction of metal ions is 0.0025 to 2% by weight, based on the total weight of the casing or of the relevant layer of the casing.

9. The food casing as claimed in claim 1, wherein said food casing is multi-layered and at least the outer layer comprises at least one antibacterially active metal salt.

10. The food casing as claimed in claim 1, wherein said food casing is tubular.

11. The food casing as claimed in claim 1, wherein said food casing is unstretched.

12. The food casing as claimed in claim 1, wherein said food casing is biaxially stretched.

13. The food casing as claimed in claim 1, wherein said food casing is multi-layered and comprises layers based on polyolefins, polyesters, polyvinylidene chloride, polyethylene-co-vinyl acetate and/or polyethylene-co-methyl methacrylate.

14. The food casing as claimed in claim 13, wherein said food casing has no more than 5 layers.

15. The food casing as claimed in claim 13, wherein said food casing has a symmetrical structure.

16. The food casing as claimed in claim 13, wherein said food casing has an asymmetrical structure.

17. The food casing as claimed in claim 1, wherein said food casing is presoaked ready-to-stuff.

18. The food casing as claimed in claims 1, wherein said food casing has a wall thickness of 15 to 150 μm.

19. The food casing as claimed in claim 1, wherein said food casing has a diameter of about 20 to 200 mm.

20. A method for producing a food casing as claimed in claims 1, which comprises mixing a master batch which comprises about 5 to 40% by weight of at least one antimicrobially active metal salt with the remaining constituents of the casing or the relevant layer of the casing and then extruding or coextruding the mixture.

21. The method as claimed in claim 20, wherein the master batch comprises as support material a polyolefin.

22. The method as claimed in claim 21, wherein said polyolefin comprises polyethylene, a polypropylene, a copolymer having ethylene and propylene units, an ethylene/(C₄-C₈) α-olefin copolymer, a propylene/(C₄-C₈) α-olefin copolymer, or an ethylene/propylene/(C₄-C₈) α-olefin copolymer, or a polyamide.
